(19) United States
(12) Patent Application Publication
(10) Pub. No.: US 2026/0083124 A1
(43) Pub. Date: Mar. 26, 2026

(54) Insect Repellant Formulation

(71) Applicant: Michael Lyon, Redlands, CA (US)

(72) Inventor: Michael Lyon, Redlands, CA (US)

(21) Appl. No.: 18/893,803

(22) Filed: Sep. 23, 2024

(51) Int. Cl. A01N 37/16; A01N 25/04; A01N 31/02; A01N 37/02; A01N 61/00; A01N 65/22; A01N 65/44; A01P 1/00; A01P 17/00

(52) U.S. Cl. CPC A01N 37/16; A01N 25/04; A01N 31/02; A01N 37/02; A01N 61/00; A01N 65/22; A01N 65/44; A01P 1/00; A01P 17/00

(57) ABSTRACT

A formulation for repelling ticks and insects has, by weight: 5-25% medium-chain triglycerides derived from natural sources, and 0.1-6% medium-chain fatty acids derived from natural sources. The pH of the formulation is approximately 7, and the formulation does not contain N,N-Diethyl-meta-toluamide (NEET).

### BACKGROUND OF THE INVENTION

### Field of the Invention

This invention relates generally to insect repellent formulations, and more particularly to an insect and tick repellent formulation containing an effective amount of medium-chain fatty acids derived from natural sources.

### Description of Related Art

Most water-based products (i.e. a product containing at least 50% water) require the use of preservatives. Preservatives are generally perceived negatively by the public, and their presence can increase the toxicity of the formulation. In other cases, such as for use on pets, bedding, etc., the presence of preservatives may pose an unacceptable risk.

Water-based formulations for insect repellents are ideal for their low cost, improved texture, non-staining, and quick drying characteristics. However, water-based formulations have unique drawbacks including the need for significant chemical preservatives, moderate to high vapor pressures, poor durability of the coating when exposed to water, and the need for pH adjustment as a microbe control strategy.

N,N-Diethyl-meta-toluamide (DEET), the most effective and long-lasting repellent currently available commercially, has long been considered the gold standard in insect repellents, but with reported human health issues, particularly for infants and pregnant women.

We present a unique combination of oil-based active ingredients that completely addresses these challenges.

### SUMMARY OF THE INVENTION

The present invention teaches certain benefits in construction and use which give rise to the objectives described below.

The present invention provides a formulation for repelling ticks and insects, said formulation comprising, by weight: 5-25% medium-chain triglycerides derived from natural sources and 2-6% of a medium-chain fatty acid derived from natural sources, wherein the pH of the formulation is approximately 7, and wherein the formulation does not contain N,N-Diethyl-meta-toluamide.

A primary objective of the present invention is to provide a formulation having advantages not taught by the prior art.

Another objective is to provide a formulation having an effective amount of medium-chain fatty acids derived from natural sources.

A further objective is to provide a formulation having a low vapor pressure such that the formulation remains effective as an insect and tick repellant for at least five hours after depositing on a surface.

Other features and advantages of the present invention will become apparent from the following more detailed description, taken in conjunction with the accompanying drawings, which illustrate, by way of example, the principles of the invention.

### DETAILED DESCRIPTION OF THE INVENTION

The below specification illustrates the invention, an insect repellent formulation for repelling insects and ticks.

The present invention utilizes medium-chain fatty acids derived from natural sources, without the need for N,N-Diethyl-meta-toluamide, or preservatives, discussed in greater detail below. This formulation may be water based, with the active oil-based ingredients being emulsified in water, so that the formulation may be used as a lotion, spray, roll-on, balm, etc., or any other suitable delivery method for application onto a surface such as skin, hair, fabric, and similar.

For purposes of this application, the term “medium chain triglycerides” is defined to include three bonded having an aliphatic tail of 6-12 carbon atoms. For the purposes of this application, the term “medium chain fatty acids” is defined to include a single unbonded fatty acid having an aliphatic tail of 6-12 carbon atoms. For the purposes of this application, the term “natural sources” is defined to include any naturally occurring materials that are not produced via a man-made chemical process.

The present application claims all logical combinations of the below-described ingredients in the presence of suitable inert ingredients including but not limited to: edible oils, edible gums, edible waxes, edible butters, surfactants, emulsifiers, texturing agents, skin conditioning agents, inorganic and organic salts, organic solvents, and water. These and other components are broadly used in consumer products meant for human use, including cosmetics (lotions, creams, shampoo, soaps, etc.). Thus these components are well-tolerated on the skin and may have a pleasing, non-greasy texture on the skin, though the formulation may be adapted to be deposited on other surfaces, such as fabric, plastic, etc.

In various embodiments, the formulation comprises, by weight, approximately 5-25% medium-chain triglycerides derived from natural sources (hereon, MCT). In many prior art formulations, soybean oil is used as a base ingredient, but the present embodiment employs a novel use of MCT from coconut oil and/or palm oil instead. The resultant ingredient demonstrates a lower viscosity, a better public perception, a more cosmetically pleasing appearance and scent, and a better texture than soybean oil. Further, MCT is reported in recent studies to have several benefits in personal care products including enhancement of skin hydration, texture, and product spread-ability. In some embodiments, the formulation also specifically includes the medium chain fatty acid Lauric Acid, which exhibits high repellency. In many prior art formulations, soybean oil is used as a base ingredient, but the present embodiment employs a novel use of coconut oil and/or palm oil instead. Recent studies indicate that this fatty mixture has repelling efficacy that is at least as effective as the commonly-used N,N-Diethyl-meta-toluamide (DEET). Coconut oil and palm oil fatty acids are active against a broad array of blood-sucking arthropods including biting flies, ticks, bed bugs and mosquitoes. Specifically, the medium-chain length fatty acids from C8:0 to C12:0 were found to exhibit the predominant repellent activity. In laboratory bioassays, these fatty acids repelled biting flies and bed bugs for two weeks after application, and ticks for one week. Repellency was stronger and with longer residual activity than that of DEET. In addition, repellency was also found against mosquitoes. In one example, an aqueous starch-based formulation containing natural coconut fatty acids was also prepared and shown to protect pastured cattle from biting flies up to 96-hours in the summer heat. Similarly, the formulation further may be formulated without the commonly-used repellent Picaridin.

The formula is antimicrobial and does not contain preservatives. Further to this, in various embodiments, the pH of the formulation is approximately 7. In prior art formulations, pH adjustment away from 7 may increase the risk of the product to the end user (i.e. use on pets, fabrics, etc.), but is necessary as a microbe control strategy. However, pH adjustment away from neutral pH (i.e. pH of approximately 7) is not necessary when the claimed combination of ingredients is present. Said combination of ingredients in a water-based formulation is self-preserving, and the addition of chemical preservatives is unnecessary. In this manner, pH modification to control microbe growth is unnecessary. Most water-based products (i.e. a product containing at least 50% water) require the use of preservatives, which are negatively perceived by the public, and in many cases present an unacceptable risk. To summarize, when the claimed combination of ingredients is present within a water-based formulation, a traditional preservative is unnecessary due to the anti-microbial properties imparted by these ingredients.

In its essential form, the formulation does not include water, but may be capable of being mixed into aqueous formulations. Water-based formulations have unique drawbacks including the need for significant chemical preservatives, moderate to high vapor pressures, poor durability of the coating when exposed to water, and the need for pH adjustment as a microbe control strategy. However, when the formulation is combined with water its ingredients completely address these drawbacks, significantly enhancing the quality of the resulting aqueous formulation. In various embodiments, the oil based ingredients are emulsified in a water base by the use of an emulsifier/surfactant and/or solvent combination depending on the formula. Ingredients in this role may include, but are not limited to, glyceryl stearate, sodium stearate, potassium stearate, Polyglyceryl oleate, and/or isopropyl alcohol.

In some embodiments, the formulation may further include at least one Essential Oil. In some embodiments, the formulation comprises approximately 0.25-5.0% of the at least one Essential Oil. In one embodiment, the at least one Essential Oil includes Lemongrass and Rosemary. Lemongrass Essential Oil has anti-inflammatory antifungal, antibacterial, and antioxidant properties, as well as having some uses as an insect repellent, pain reliever, and other uses. Rosemary Essential Oil also has insect repellent properties, as well as other well-known benefits such as antioxidant purposes.

In some embodiments, the formulation further includes 1-4% Geraniol. Geraniol has insect repellent and pesticidal properties, as well as anti-inflammatory, antimicrobial, antibacterial, antioxidant, and antibacterial properties.

In use, the formulation has a low vapor pressure such that the formulation remains effective as an insect and tick repellant for at least five hours after depositing on a surface, in some cases ten hours or more. This length of efficacy is similar to that of other commercial applications, including DEET and Picaridin containing products. The hydrophobic nature of these components imparts a water-resistant characteristic to these ingredients once they have deposited on a surface (fabric, rubber, human skin, pet hair, etc.). The extended efficacy is in part attributed to this water-resistance. The relatively low vapor pressure of these components leads to a slow rate of evaporation once they have deposited on a surface (fabric, rubber, human skin, pet hair, etc.). The extended efficacy is in part attributed to this low vapor pressure. Furthermore, in the quantities listed, the resulting mixture has a uniquely low vapor pressure compared to most other insect and tick repelling/killing products.

Below is one embodiment of a combination of oil-based ingredients suitable for use in water-based insect and tick repelling and/or killing formulas:
i. Lauric Acid-Up to 6% w/w
ii. Geraniol-Up to 3% w/w
iii. Lemongrass Essential Oil-Up to 0.50% w/w
iv. Rosemary Essential Oil-Up to 0.50% w/w
v. Medium Chain Triglycerides derived from coconut oil-Up to 25% w/w

This combination has a minimal to mild scent that is acceptable to most consumers, with ingredients that can be 100% naturally sourced. As discussed, additional ingredients may be included, and the formulation is highly capable of mixing with other formulations. Furthermore, while a one example of weight percentages are described, a wide range of possible weight percentages may be used, and the given percentages are intended only for the purpose of example.

Specific types of products using the claimed formulation may include a liquid, balm, lotion, shelter spray, pet spray, bed bug spray, insect kill-on-contact spray, or any other type of product that may be usefully produced within the limitations of the presented claims.

In one embodiment of a balm product, the formulation comprises, by weight: 20% Beeswax; 64% Almond Oil; 5% MCT; 6% Lauric Acid; 1% Vitamin E, 3% Geraniol, 0.50% Lemongrass Essential Oil, and 0.25% Rosemary Essential Oil.

In one embodiment of a lotion product, the formulation comprises, by weight: 64% Water; 10% Glyceryl Stearate SE; 5% Cocoa Butter; 5% Almond Oil; 5% MCT; 6% Lauric Acid; 1% Vitamin E; 3% Geraniol; 0.50% Lemongrass Essential Oil; 0.25% Rosemary Essential Oil.

In one embodiment of a liquid repellant product, the formulation comprises, by weight: 0.25% Rosemary Essential Oil; 0.25% Peppermint Essential Oil; 0.50% Lemongrass Essential Oil; 1% Geraniol; 2% Lauric Acid; 21% MCT Oil; and 75% Walnut Oil.

In one embodiment of a water-based liquid repellant product, the formulation comprises, by weight: 1% Geraniol; 0.25% Lemongrass Essential Oil; 0.12% Rosemary Essential Oil; 75% Water; 5% MCT Oil; 5% Almond Oil; 4% Lauric Acid; 4% Polyglyceryl Oleate; 2% Glycerin; 1% Gum Arabic (Acacia), and 1% Vitamin E.

Each of the provided embodiments are intended only for the purpose of the example, and should not be interpreted as limiting the potential claimed formulation to these embodiments. Furthermore, all given percentages should be interpreted as approximate, with some variance being possible.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean+/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A formulation for repelling ticks and insects, said formulation comprising:
5-25%, by weight, medium-chain triglycerides derived from natural sources;
0.1-6%, by weight, medium-chain fatty acids derived from natural sources;
wherein the pH of the formulation is approximately 7; and
wherein the formulation does not contain N,N-Diethyl-meta-toluamide.

2. The formulation of claim 1, further comprising 0.25-5.0%, by weight, of at least one Essential Oil.

3. The formulation of claim 2, wherein the at least one Essential Oil includes Lemongrass or Rosemary.

4. The formulation of claim 1, further comprising 1-4%, by weight, geraniol.

5. The formulation of claim 1, wherein the medium-chain fatty acids include Lauric Acid.

6. The formulation of claim 1, wherein the formulation is in an aqueous formulation.

7. The formulation of claim 1, wherein the formulation does not include Picaridin.

8. The formulation of claim 1, wherein the formulation is antimicrobial and does not contain preservatives.

9. The formulation of claim 1, wherein the formulation has a low vapor pressure such that the formulation remains effective as an insect and tick repellant for at least five hours after depositing on a surface.

10. The formulation of claim 1, further comprising an emulsifier.

11. The formulation of claim 10, wherein the emulsifier is in the form of one or more of the following ingredients: glyceryl stearate, sodium stearate, potassium stearate, Polyglyceryl oleate, and isopropyl alcohol.

12. The formulation of claim 1, wherein the formulation of is emulsified in a water base.

13. The formulation of claim 1, wherein the formulation of is emulsified in a water base and is provided in the form of a lotion, spray, roll-on, balm, or wire.

14. A formulation for repelling ticks and insects, the formulation comprising:
a water base; and
oil based active ingredients emulsified in the water base, the oil based active ingredients comprising:
5-25%, by weight, medium-chain triglycerides derived from coconut oil;
0.1-6%, by weight, medium-chain fatty acids derived from natural sources;
wherein the pH of the formulation is approximately 7;
0.1-5.0%, by weight, geraniol; and
0.25-5.0%, by weight, of lemongrass essential oil and rosemary essential oil.
